(19) United States
(12) Patent Application Publication
(10) Pub. No.: US 2018/0336412 A1
(43) Pub. Date: Nov. 22, 2018

(54) COMPUTER VISION ROBOT CONTROL

(71) Applicant: SPHERO, INC., Boulder, CO (US)

(72) Inventor: Stanley James, Louisville, CO (US)

(73) Assignee: SPHERO, INC., Boulder, CO (US)

(21) Appl. No.: 15/982,793

(22) Filed: May 17, 2018

Related U.S. Application Data
(60) Provisional application No. 62/507,571, filed on May 17, 2017.

(51) Int. Cl. G06K 9/00; B25J 9/16

(52) U.S. Cl. CPC G06K 9/00664; G06K 9/00281; Y10S 901/47; G06K 9/00335; B25J 9/1697; G06K 9/00302

(57) ABSTRACT

Aspects of the present disclosure relate to computer vision robot control. As an example, a user device may use one or more cameras to process received visual data and generate control instructions for a robot. In some examples, a camera may be part of the user device, remote from the user device, part of the robot, or any combination thereof. Control instructions may be based on facial recognition and/or object recognition, among other computer vision techniques. As a result, the user may be able to more directly interact with the robot and/or control the robot in ways that were not previously available using simple user input methods.

### CROSS-REFERENCE TO RELATED APPLICATION

This application claims priority to U.S. Provisional Application No. 62/507,571, entitled “Computer Vision Robot Control,” filed on May 17, 2017, the entire disclosure of which is hereby incorporated by reference in its entirety.

### BACKGROUND

A robot may be remotely controlled by a user, wherein the robot may receive control instructions from an electronic device controlled by the user. However, user interaction with the robot itself may be diminished as a result of the user interacting directly with the electronic device when controlling the robot.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to computer vision robot control. As an example, a user device may use one or more cameras to process received visual data and generate control instructions for a robot. In some examples, a camera may be part of the user device, remote from the user device, part of the robot, or any combination thereof. Control instructions may be based on facial recognition and/or object recognition, among other computer vision techniques. As a result, the user may be able to more directly interact with the robot and/or control the robot in ways that were not previously available using simple user input methods.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIGS. 1 illustrates an overview of an example system for computer vision robot control.

FIG. 2 illustrates an overview of an example method for computer vision robot control based on a facial characteristic.

FIG. 3 illustrates an overview of an example method for computer vision robot control based on object detection.

FIG. 4 illustrates an example operating environment in which one or more of the present embodiments may be implemented.

### DETAILED DESCRIPTION

A robot may be remotely controlled by a user device, wherein the user device may be a mobile computing device, a tablet computing device, a laptop computing device, or a desktop computing device, among other electronic devices. In an example, the user device may provide a user interface (UI) for receiving simple movement instructions from the user (e.g., move forward or backward, turn left or right, speed up or slow down, etc.), which may cause movement control instructions to be provided to the robot to control its movement. However, user interaction with the user interface may reduce user engagement with the robot. Accordingly, the systems and methods disclosed herein relate to computer vision robot control, wherein the user device may use one or more cameras to process received visual data and generate control instructions for a robot. As a result, the user may be able to more directly interact with the robot and/or control the robot using techniques that were not previously available while using the simple user input methods provided by the above-described UI.

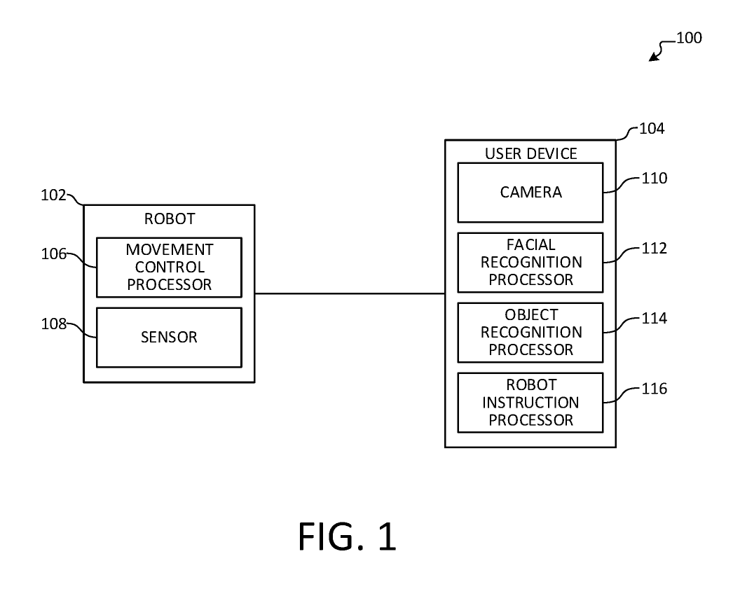

FIG. 1 illustrates an overview of an example system 100 for computer vision robot control. As illustrated, system 100 comprises robot 102 and user device 104. Robot 102 may be any type of remote-controlled robot, such that robot 102 may receive instructions from a user device (e.g., user device 104) and process and respond to the received instructions accordingly. In an example, user device 104 may be a mobile computing device, a tablet computing device, a laptop computing device, or a desktop computing device, among other electronic devices. User device 104 and robot 102 may communicate using any of a variety of mechanisms, including, but not limited to, infrared or other optical communication, radio or wireless communication (e.g., Wi-Fi, Bluetooth, etc.), or wired communication.

Robot 102 may comprise movement control processor 106 and sensor 108. Movement control processor 106 may control the movement of robot 102. As an example, movement control processor 106 may receive control instructions from user device 104, which may be used by movement control processor 106 to cause the robot to move (e.g., using one or more motors, not pictured) or perform other actions (e.g., generate audio feedback, generate visual feedback, etc.). Sensor 108 may be any of a variety of sensors used to sense information relating to robot 102, including, but not limited to, an accelerometer, a gyroscope, or a light sensor. Information from sensor 108 may be evaluated by movement control processor 106 when controlling the movement of robot 102. In some examples, at least a part of the data from sensor 108 may be provided by robot 102 to user device 104, such that user device 104 may perform additional processing based on the received sensor data. While robot 102 is shown as having one sensor, it will be appreciated that additional, fewer, or alternative sensors may be used without departing from the spirit of this disclosure.

In examples, user device 104 may comprise camera 110, facial recognition processor 112, object recognition processor 114, and robot instruction processor 116. In an example, camera 110 may be a front-facing or back-facing camera of user device 104. In a front-facing camera example, camera 110 may provide visual data to facial recognition processor 112, which may be used to identify the faces of one or more users of user device 104. Facial recognition processor 112 may identify facial characteristics, including, but not limited to, facial expressions, emotions, or facial features.

In a back-facing camera example, camera 110 may provide visual data to object recognition processor 114, which may be used to identify objects within the received visual data. As an example, object recognition processor may identify robot 102 in a scene, as well as one or more obstacles, other robots, or other objects. In some examples, object recognition processor 114 may initially receive a reference scene, wherein the scene does not consist of robot 102. Object recognition processor 114 may then use the reference scene when processing subsequent visual data in order to identify differences between the reference scene and the current scene, such that robot 102 and/or one or more objects may be identified. In an example, visual data from camera 110 may be recorded as a video and stored for later playback. It will be appreciated that while example uses are described for a front-facing camera and a back-facing camera, either camera may be used to perform the aspects described herein.

While example techniques are described herein, it will be appreciated that any of a variety of computer vision processing techniques may be used. In some examples, camera 110 may capture both a scene and one or more faces (e.g., it may be a 360-degree camera, a user of user device 104 may be visible in the same frame as the scene, etc.). Further, while user device 104 is illustrated as having one camera, it will be appreciated that multiple cameras may be used without departing from the spirit of this disclosure. In some examples, one or more of elements 110-116 may be remote from user device 104, such that another computing device may provide the functionality described herein. As an example, a remote camera may provide visual data to facial recognition processor 112 and/or object recognition processor 114.

Robot instruction processor 116 may generate control instructions, which may be provided to robot 102 to control the behavior of robot 102. As an example, facial recognition processor 112 may process visual data received from camera 110, the result of which may be provided to robot instruction processor 116. Robot instruction processor 116 may use the facial recognition information to generate a control instruction for robot 102, which may be transmitted to robot 102. For example, if facial recognition processor 112 detects that a user is smiling, the facial recognition information may comprise such an indication, which may be used by robot instruction processor 116 to generate a control instruction instructing robot 102 to move forward. Movement control processor 106 may receive the control instruction and may control one or more motors (not pictured) of robot 102 to cause robot 102 to move forward. It will be appreciated that other actions may be performed based on received facial recognition information without departing from the spirit of this disclosure, including, but not limited to, turning the robot off or on, changing the color of one or more LEDs of the robot, or controlling the volume of one or more sound effects.

In another example, robot instruction processor 116 may receive object recognition information from object recognition processor 114, which may be used to generate control information. The object recognition information may comprise location information for robot 102, and, in some examples, location information for one or more objects. As a result, robot instruction processor 116 may generate a control instruction to move robot 102 while avoiding the identified obstacle. In other examples, the object recognition information may comprise a location to which a user is pointing, such that robot instruction processor 116 may generate a control instruction to move robot 102 to the location to which the user is pointing. Object recognition information from object recognition processor 114 may be used to provide a user interface on user device 104, wherein the user interface may comprise a visual representation of a scene observed by camera 110. The user of user device 104 may indicate a location within the visual representation. The indication may be used by robot instruction processor 116 to generate a control instruction to navigate robot 102 to the physical location analogous to the indicated location in the visual representation on user device 104. In another example, a path may be drawn by the user, such that object recognition processor 114 may detect the path. The identified path may be used by robot instruction processor 116 to generate a control instruction to move the robot along the path.

Robot instruction processor 116 may evaluate information received from robot 102 (e.g., accelerometer data, telemetry or location data as may be generated by movement control processor 106, etc.) when generating a control instruction. As an example, if a scene comprises an additional robot (not pictured) and robot 102, robot instruction processor 116 may evaluate sensor data from sensor 108 to determine whether the two robots in the scene collided or merely passed by one another.

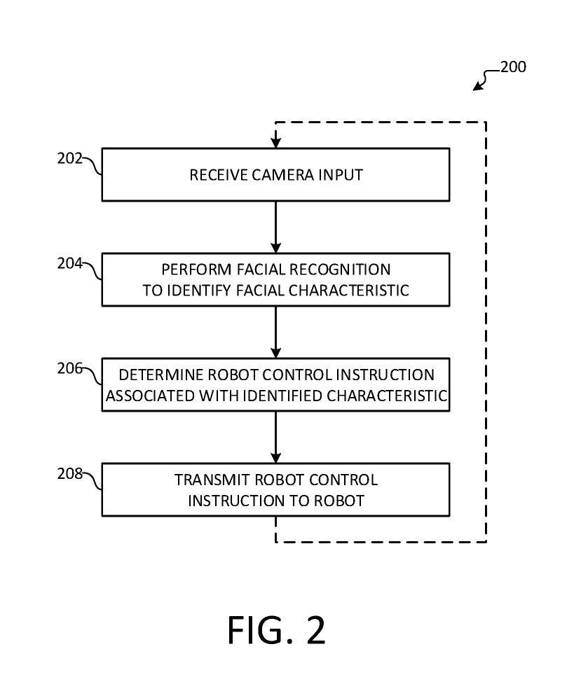

FIGS. 2 illustrates an overview of an example method 200 for computer vision robot control based on a facial characteristic. Method 200 may be performed by a user device, such as user device 104 in FIG. 1. Method 200 begins at operation 202, where camera input may be received. Camera input may be received from one or more cameras, such as camera 110 in FIG. 1. In examples, camera input may comprise a still image, a sequence of images, a video file or stream, among other visual data. In some examples, the camera input may be received from a local or remote camera.

Moving to operation 204, facial recognition may be performed using the received camera input to identify a facial characteristic. In an example, facial recognition may be performed using a facial recognition processor, such as facial recognition processor 112 in FIG. 1. In other examples, performing facial recognition may comprise determining one or more facial features, expressions, and/or an identity of a user, among other characteristics. Facial recognition may be performed locally, or at least a part of the received camera input may be provided to a remote computing device, such that the remote computing device may perform facial recognition and provide facial recognition information in response. While aspects of method 200 are discussed with respect to performing facial recognition based on one face, it will be appreciated that other examples may comprise performing facial recognition based on multiple faces.

At operation 206, a robot control instruction associated with the identified characteristic may be determined. In an example, a data store may comprise one or more associations of facial characteristics and control instructions. Determining the control instruction may comprise identifying a control instruction in the data store that is associated with the identified facial characteristic. In some examples, at least a part of the associations may be specified by a user, such that the user may indicate that a certain facial characteristic should be associated with a certain control instruction. In other examples, a control instruction may vary depending on the type of facial characteristic that was identified and/or the magnitude of an attribute of the facial characteristic (e.g., how high eyebrows are raised, the size of a smile, the extent to which a user's eyes are open, etc.). For example, if the identified facial characteristic comprises raised eyebrows, a control instruction relating to the speed of the robot may be generated, wherein the magnitude of the speed is determined based on how high the eyebrows are raised. In an example, a forward control instruction may be generated for a smile facial expression, a backward control instruction may be generated for a puckered lips facial expression, or a left or right control instruction may be generated based on an identified tilt as part of the user's facial expression. While example facial characteristic are discussed herein, it will be appreciated that any of a variety of facial expressions, features, or other characteristics may be used to generate a control instruction without departing from the spirit of this disclosure.

Moving to operation 208, the generated control instruction may be transmitted to the robot. In an example, the control instruction may be transmitted using any of a variety of mechanisms, including, but not limited to infrared or other optical communication, radio or wireless communication (e.g., Wi-Fi, Bluetooth, etc.), or wired communication. As illustrated by the dashed arrow from operation 208 to operation 202, flow may loop through operations 202-208, thereby enabling a user to control the robot with a series of facial characteristics. In other examples, flow terminates at operation 208.

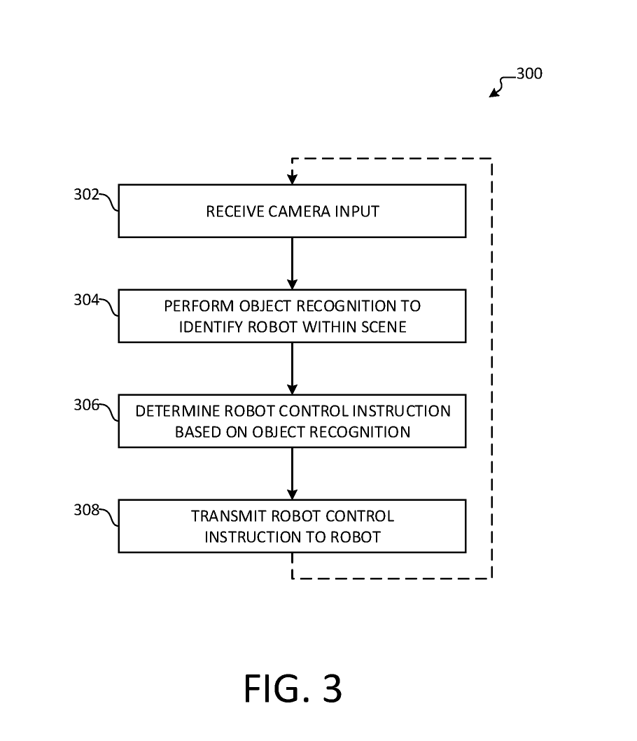

FIG. 3 illustrates an overview of an example method 300 for computer vision robot control based on object detection. Method 300 may be performed by a user device, such as user device 104 in FIG. 1. Method 300 begins at operation 302, where camera input may be received. Camera input may be received from one or more cameras, such as camera 110 in FIG. 1. In examples, camera input may comprise a still image, a sequence of images, a video file or stream, among other visual data. In some examples, the camera input may be received from a local or remote camera. In an example, the received camera input may comprise a scene, wherein the scene may comprise a robot.

Moving to operation 304, object recognition may be performed using the received camera input to identify the robot within the scene. In an example, object recognition may be performed using an object recognition processor, such as object recognition processor 114 in FIG. 1. In other examples, performing object recognition may comprise identifying one or more objects in the scene, including, but not limited to, obstacles, a part of user (e.g., a finger, hand, face, etc.), or another robot. Object recognition may be performed locally, or at least a part of the received camera input may be provided to a remote computing device, such that the remote computing device may perform object recognition and provide object recognition information in response. In some examples, object recognition may comprise recognizing a surface on which the robot is operating. The surface may be a game board, an obstacle course, or other surface. In an example, the surface may be identified based on a barcode, a Quick Response (QR) code, or any other type of identifier, such that features of the surface may be identified using the identifier rather than or in addition to the computer vision aspects described herein. For example, the identifier may be recognized, such that surface information (e.g., type of surface, obstacles that may be present, etc.) may be determined or otherwise known without requiring additional object recognition processing.

At operation 306, a robot control instruction may be determined based on the object recognition. The robot control instruction may comprise movement instructions, such as instructing the robot to move forward, backward, turn, etc. In some examples, the robot may already be moving, and the control instruction may indicate that the robot should continue moving or should change direction or speed, among other instructions. The control instruction may be determined based on the identified position of the robot in the scene. As an example, if it is determined that the robot is approaching an edge of a surface or an obstacle, a control instruction may be generated to instruct the robot to stop or to change direction. In another example, if a path has been detected in the scene, a control instruction may be generated for the robot so as to keep the robot on the path. In some examples, one or more virtual boundaries may be defined within the scene, such that a control instruction may be generated to keep the robot within a set of boundaries or to prevent the robot from crossing a boundary. In other examples, information relating to a surface (e.g., as may be determined based on an identifier as discussed above with respect to operation 304) may be evaluated when determining a robot control instruction. While example control instructions based on object recognition are discussed herein, it will be appreciated that any of a variety of other control instructions based on object recognition may be generated without departing from the spirit of this disclosure.

Moving to operation 308, the generated control instruction may be transmitted to the robot. In an example, the control instruction may be transmitted using any of a variety of mechanisms, including, but not limited to infrared or other optical communication, radio or wireless communication (e.g., Wi-Fi, Bluetooth, etc.), or wired communication. As illustrated by the dashed arrow from operation 308 to operation 302, flow may loop through operations 302-308, thereby enabling robot control based on object recognition. In other examples, flow terminates at operation 308.

At least a part of methods 200 and 300 may be performed together, such that a robot may be controlled based on both facial and object recognition. As an example, object recognition may be used to generate a control instruction to avoid an obstacle even if a determined facial characteristic may be associated with a control instruction to move forward into the object. In another example, an identified facial characteristic may indicate that a control instruction should be provided to the robot even though object recognition may indicate that performing the control instruction would result in a collision.

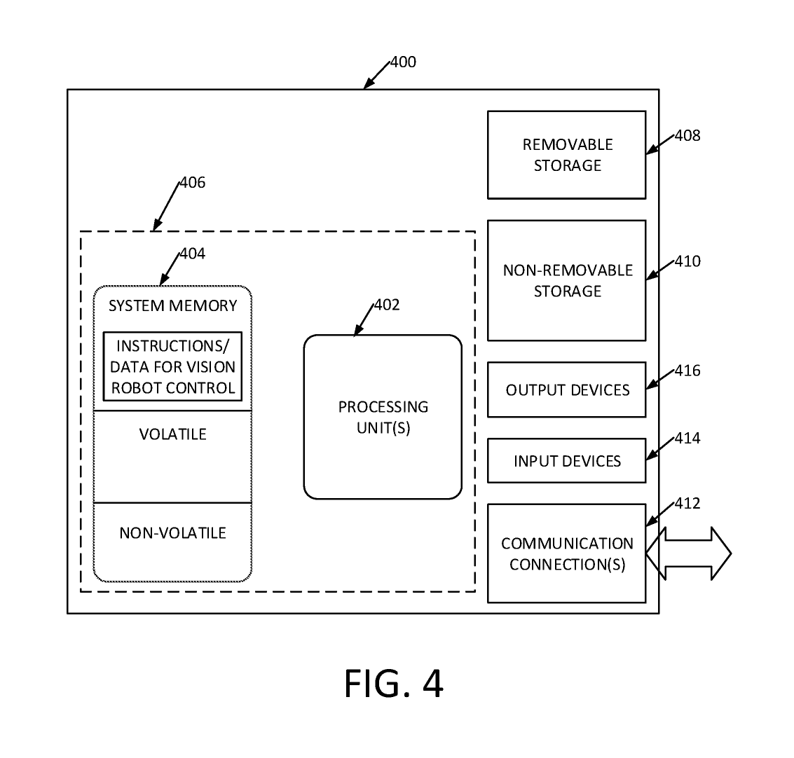

FIG. 4 illustrates an example operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically includes at least one processing unit 402 and memory 404. Depending on the exact configuration and type of computing device, memory 404 (instructions to perform the computer vision robot control operations disclosed herein) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a system for controlling a robot, comprising: at least one processor; and memory encoding computer executable instructions that, when executed by the at least one processor, perform a method. The method comprises: receiving, by a user device, visual data from a camera; generating, based on the received visual data, facial recognition information comprising a facial characteristic for a user of the user device; determining a control instruction associated with the facial characteristic, wherein the control instruction is associated with the facial characteristic in a data store; and providing the determined control instruction to the robot. In an example, the method further comprises: generating, based on the received visual data, object recognition information comprising at least one object. In another example, the control instruction is determined based at least in part on the at least one object. In a further example, determining the control instruction comprises: analyzing a magnitude associated with the facial characteristic; and adapting the control instruction based on the magnitude. In yet another example, the facial characteristic is one of: a facial expression; an emotion; and a facial feature. In a further still example, the control instruction is associated with the facial expression in the data store as a result of an indication received from the user. In another example, the user device comprises the camera.

In another aspect, the technology relates to a method for generating a control instruction based on visual input. The method comprises: receiving, by a user device, visual data from a camera, wherein the visual data comprises a view of a robot; generating, based on the received visual data, object recognition information comprising the robot and at least one object; determining a control instruction for the robot based on the generated object recognition information; and providing the determined control instruction to the robot. In an example, the method further comprises: generating, based on the received visual data, facial recognition information comprising a facial characteristic for a user of the user device. In another example, the control instruction is determined based at least in part on the facial characteristic for the user. In a further example, the at least one object is another robot, and determining the control instruction comprises analyzing movement of the another robot. In yet another example, the at least one object is a path, and determining the control instruction comprises analyzing the path in relation to a position of the robot. In a further still example, determining the control instruction comprises a comparison of the object recognition information to previous object recognition information.

In a further aspect, the technology relates to another method for controlling a robot. The method comprises: receiving, by a user device, visual data from a camera; generating, based on the received visual data, facial recognition information comprising a facial characteristic for a user of the user device; determining a control instruction associated with the facial characteristic, wherein the control instruction is associated with the facial characteristic in a data store; and providing the determined control instruction to the robot. In an example, the method further comprises: generating, based on the received visual data, object recognition information comprising at least one object. In another example, the control instruction is determined based at least in part on the at least one object. In a further example, determining the control instruction comprises: analyzing a magnitude associated with the facial characteristic; and adapting the control instruction based on the magnitude. In yet another example, the facial characteristic is one of: a facial expression; an emotion; and a facial feature. In a further still example, the control instruction is associated with the facial expression in the data store as a result of an indication received from the user. In another example, the user device comprises the camera.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system for controlling a robot, comprising:
at least one processor; and
memory encoding computer executable instructions that, when executed by the at least one processor, perform a method comprising:
receiving, by a user device, visual data from a camera;
generating, based on the received visual data, facial recognition information comprising a facial characteristic for a user of the user device;
determining a control instruction associated with the facial characteristic, wherein the control instruction is associated with the facial characteristic in a data store; and
providing the determined control instruction to the robot.

2. The system of claim 1, wherein the method further comprises:
generating, based on the received visual data, object recognition information comprising at least one object.

3. The system of claim 2, wherein the control instruction is determined based at least in part on the at least one object.

4. The system of claim 1, wherein determining the control instruction comprises:
analyzing a magnitude associated with the facial characteristic; and
adapting the control instruction based on the magnitude.

5. The system of claim 1, wherein the facial characteristic is one of:
a facial expression;
an emotion; and
a facial feature.

6. The system of claim 1, wherein the control instruction is associated with the facial expression in the data store as a result of an indication received from the user.

7. The system of claim 1, wherein the user device comprises the camera.

8. A method for generating a control instruction based on visual input, comprising:
receiving, by a user device, visual data from a camera, wherein the visual data comprises a view of a robot;
generating, based on the received visual data, object recognition information comprising the robot and at least one object;
determining a control instruction for the robot based on the generated object recognition information; and
providing the determined control instruction to the robot.

9. The method of claim 8, further comprising:
generating, based on the received visual data, facial recognition information comprising a facial characteristic for a user of the user device.

10. The method of claim 9, wherein the control instruction is determined based at least in part on the facial characteristic for the user.

11. The method of claim 8, wherein the at least one object is another robot, and wherein determining the control instruction comprises analyzing movement of the another robot.

12. The method of claim 8, wherein the at least one object is a path, and wherein determining the control instruction comprises analyzing the path in relation to a position of the robot.

13. The method of claim 8, wherein determining the control instruction comprises a comparison of the object recognition information to previous object recognition information.

14. A method for controlling a robot, comprising:
receiving, by a user device, visual data from a camera;
generating, based on the received visual data, facial recognition information comprising a facial characteristic for a user of the user device;
determining a control instruction associated with the facial characteristic, wherein the control instruction is associated with the facial characteristic in a data store; and
providing the determined control instruction to the robot.

15. The method of claim 14, further comprising:
generating, based on the received visual data, object recognition information comprising at least one object.

16. The method of claim 15, wherein the control instruction is determined based at least in part on the at least one object.

17. The method of claim 14, wherein determining the control instruction comprises:
analyzing a magnitude associated with the facial characteristic; and
adapting the control instruction based on the magnitude.

18. The method of claim 14, wherein the facial characteristic is one of:
a facial expression;
an emotion; and
a facial feature.

19. The method of claim 14, wherein the control instruction is associated with the facial expression in the data store as a result of an indication received from the user.

20. The method of claim 14, wherein the user device comprises the camera.
